(19) United States
(12) Patent Application Publication
(10) Pub. No.: US 2008/0018168 A1
(43) Pub. Date: Jan. 24, 2008

(54) Rim Protector

(76) Inventor: Brian Conaway, Denver, CO (US)

Correspondence Address: KRAJEC PATENT OFFICES, LLC, 820 WELCH AVENUE, BERTHOUD, CO, 80513, US

(21) Appl. No.: 11/459,309

(22) Filed: Jul. 21, 2006

(51) Int. Cl. B60B 7/01

(52) U.S. Cl. 301/37.24

(57) ABSTRACT

An automobile rim edge protector is mounted to the outer surface of the rim in the range of the rim flange. The protector may be an extruded shape that is applied by adhesive, as well as a molded shape held on by other means. The protector is mounted on the outer side of the rim flange such that it does not interfere with the rim/tire interface.

### BACKGROUND

Automobile rims are often scraped and scratched when parking close to curbs and other abutments. Many high performance and cosmetic wheels are made of aluminum and other alloys which may be more prone to deep scratching than older steel rims. With the expense of replacing or refurbishing alloy wheels quite high, a mechanism that could prevent or minimize wheel damage would be welcome. It would be a further benefit if such a mechanism were easily manufactured, installed, and provided protection for such wheels.

### SUMMARY

An automobile rim edge protector is mounted to the outer surface of the rim in the area of the rim flange. The protector may be an extruded shape that is applied by adhesive, as well as a molded shape held on by other means. The protector is mounted on the outer side of the rim flange such that it does not interfere with the rim/tire interface.

### BRIEF DESCRIPTION OF THE DRAWINGS

In the drawings,

FIG. 1 is a cross-sectional view of an embodiment of a wheel rim with a protective element.

FIG. 2 is a close up cross-sectional view of an embodiment of a wheel rim with a protective element.

FIG. 3A is a cross-sectional view of an embodiment of a wheel rim with a protective element.

FIG. 3B is a cross-sectional view of an embodiment of a wheel rim with a protective element.

FIG. 3C is a cross-sectional view of an embodiment of a wheel rim with a protective element.

FIG. 3D is a cross-sectional view of an embodiment of a wheel rim with a protective element.

FIG. 3E is a cross-sectional view of an embodiment of a wheel rim with a protective element.

FIG. 3F is a cross-sectional view of an embodiment of a wheel rim with a protective element.

FIG. 4 is a perspective exploded view of an embodiment of the installation of a protective element to a wheel rim.

FIG. 5 is a perspective exploded view of an embodiment of the installation of a protective element to a wheel rim having wheel weights.

FIG. 6 is a perspective exploded view of an embodiment of a protective element with an escutcheon.

FIG. 7A is a cross-sectional view of an embodiment of a compliant and formable wheel rim with a protective element.

FIG. 7B is a cross-sectional view of an embodiment of a wheel rim with a formable protective element.

FIG. 7C is a cross-sectional view of an embodiment of a wheel rim with a formable protective element.

FIG. 7D is a cross-sectional view of an embodiment of a wheel rim with a formable protective element.

FIG. 7E is a cross-sectional view of an embodiment of a wheel rim with a formable protective element.

### DETAILED DESCRIPTION

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

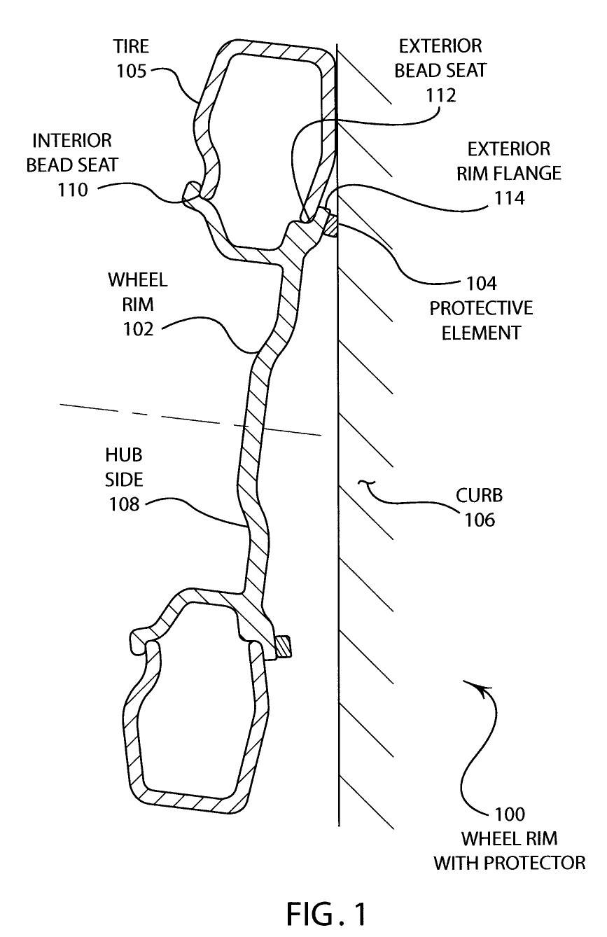

FIG. 1 is a cross-sectional diagram of an embodiment 100 showing a wheel rim with a protective element. The wheel rim 102 has a protective element 104 that protects the edge of the rim 102 from abrasion with a curb 106. The tire 105 is shown deflected when the assembly is in the position where curb abrasions occur.

The wheel rim 102 has a hub side 108, which is the interior side of the wheel rim 102 and is the side that would mate to a wheel hub, brakes, and suspension of an automobile (not shown). The wheel rim 102 further has an interior bead seat 110 and exterior bead seat 112. The bead seats 110 and 112 are the interface for the tubeless tire 105 and form an airtight seal between the wheel rim 102 and the tire 105. The exterior rim flange 114 contains the area of the wheel rim 102 that is scratched by contact with a curb 106 and is also a feature of the wheel rim 102 that is part of the mechanical tire/wheel interface.

Abrasion between the curb 106 and the wheel rim flange 114 tend to occur when a driver of an automobile or other vehicle operates the vehicle in close proximity to a curb 106, such as when parallel parking an automobile. Sometimes, the wheel rim 102 comes in contact with the curb 106 and can be scratched or otherwise damaged. In minor cases, the scratches may be unsightly abrasions, while in more serious cases, the surfaces may affect the structural integrity of the wheel rim 102.

The protective element 104 may provide some protection for the wheel rim 102 in several different manners. In some embodiments, the protective element 104 may be a replaceable item that could be damaged through contact with a curb 106, removed, and replaced. Some such embodiments may be designed for a ‘single use’ and may be replaced after one contact with a curb 106.

In another embodiment, the protective element 104 may be designed to resist abrasion and remain on the wheel rim 102 for repeated uses. Such embodiments may be designed to hide abrasion by having pigment or color through the bulk of the material that makes up a substantial portion of the protective element 104. Other such embodiments may be fashioned from materials that are known to have a high abrasion resistance such as polytetrafluoroethylene (Teflon), ultra high molecular weight polyethylene (UHMW), or other similar materials.

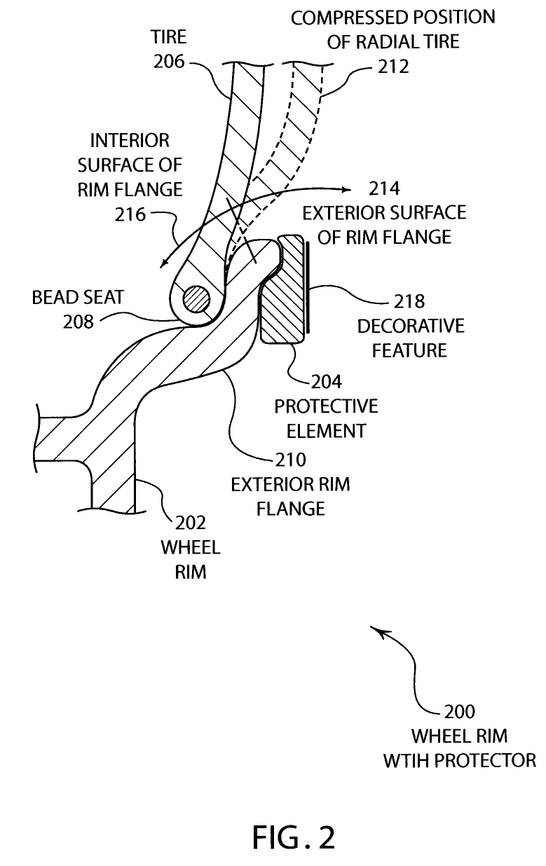

FIG. 2 is a close up cross-sectional illustration of an embodiment 200 of a wheel rim with a protective element. The wheel rim 202 has a protective element 204 attached. The tire 206 seals against the wheel rim 202 at the exterior bead seat 208 and is held in place by the exterior rim flange 210.

The tire 206 is shown in the uncompressed position, while the compressed position 212 is also shown. This is a phenomena associated with radial tires, the type of tires most commonly used on today's vehicles. The compressed position 212 represents the position of the radial tire when the tire is in contact with the ground. During the rotation, the tire flexes between the compressed position 212 at the bottom of the rotation to the uncompressed position represented by tire 206. The flexing process causes a greater or lesser portion of the tire's sidewall to come in contact with the interior face of the rim flange.

The circumferential line defining the interior surface of the rim flange 216 and the exterior surface of the rim flange 214 is the furthest point from the bead seat where the compressed portion of the radial tire 212 is in contact with the rim flange 210. The protective element 204 may be placed anywhere on the exterior surface of the rim flange 214, but if the protective element 204 were placed on the interior surface 216, the protective element 204 may interfere with the normal flexing of the radial tire 206 and lead to premature sidewall failure of the tire 206 or may adversely affect the airtight seal.

The protective element 204 may be manufactured from any type of suitable material using any type of manufacturing method. In many embodiments, an extruded form may be used and may be attached to the exterior rim flange by adhesive or mechanical fastening. Other embodiments may use a molded, cast, forged, stamped, machined, or other forming or manufacturing process. The attachment of the protective element 204 to the exterior rim flange 210 may be through pressure sensitive adhesives, two part adhesives, cyanoacrylates, or any other type of adhesive system. When a mechanical fastening system is used, any type of removable fastener such as a screw, spring clip, or other mechanical fastening means may be used. In some instances, features may be machined or molded into the wheel rim 202 to accept a molded or machined feature in the protective member 202. For example, a barbed tip may be molded into the protective member 204 that is designed to engage a hole or other receptacle in the wheel rim 202.

In some cases, a more rigid protective element 204 may be mounted on a layer of foam or other compliant material. The protective element 204 may have a decorative feature 218 that may include colored or metalized films, paint, printing, decals, two-stage molded decorations, or any other cosmetic element. In some embodiments, the decorative feature 218 may be applied to the protective element during manufacture, such as in a two-stage molding process, or the decorative feature 218 may be a decal or paint that is applied after the main portion of the protective element 204 is attached to the wheel rim 202.

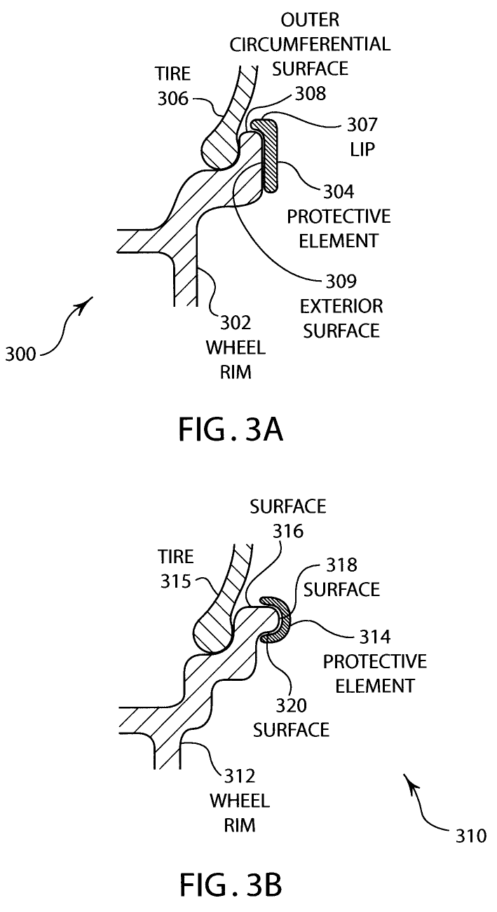

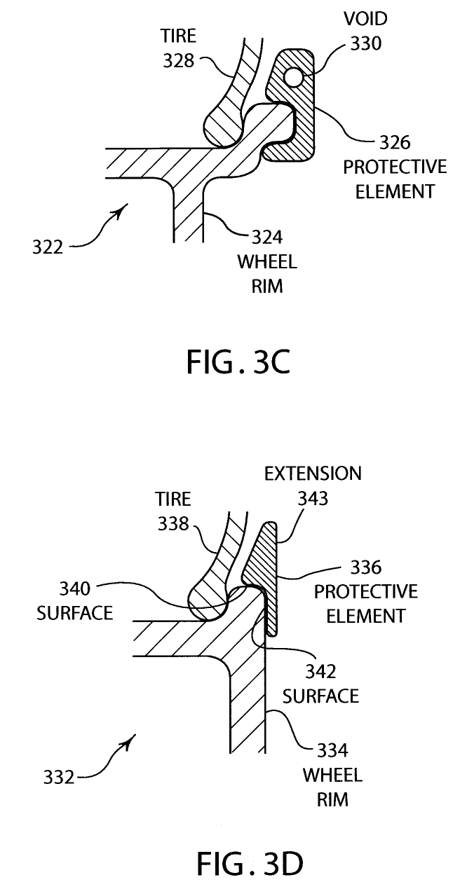

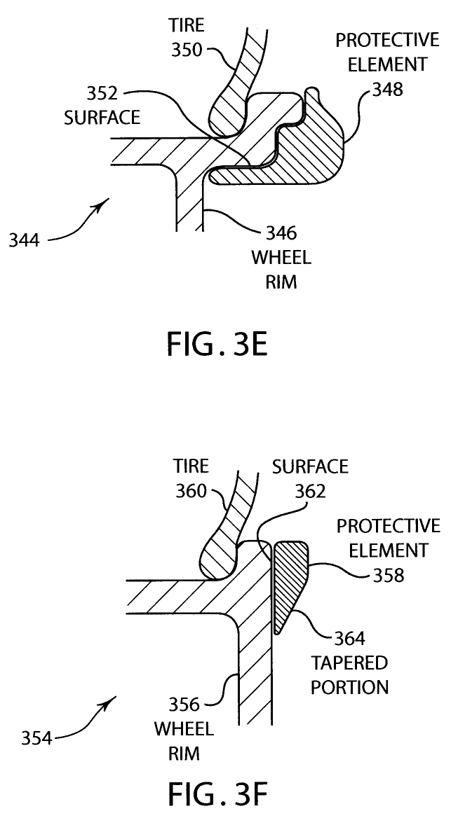

FIG. 3A is a cross-sectional illustration of an embodiment 300 showing a wheel rim 302, a protective element 304, and a tire 306. The protective element 304 is mounted to the wheel rim 302 by attaching to the outer circumferential surface 308 and the exterior surface 309. The lip 307 extends toward the tire 306, but does not come in contact with the tire nor does it interfere with the interface between the tire 306 and the wheel rim 302.

FIG. 3B is a cross-sectional illustration of an embodiment 310 showing a wheel rim 312, a protective element 314, and a tire 317. The protective element 314 is fashioned to attach to the wheel rim 312 by covering the surfaces 316, 318, and 320 of the wheel rim 312.

FIG. 3C is a cross-sectional illustration of an embodiment 322 showing a wheel rim 324, a protective element 326, and a tire 328. The protective element 326 mounts to the wheel rim 324 in a manner similar to embodiment 310. Protective element 326 has a void 330. The void 330 may be an extruded feature that may be used with an escutcheon or other device to join butt ended joints of an extruded protective element 326. In some embodiments, the void 330 may be used to reduce the material volume.

FIG. 3D is a cross-sectional illustration of an embodiment 332 showing a wheel rim 334, a protective element 336, and a tire 338. The protective element 336 is mounted to surfaces 340 and 342 and has an extension 343 that extends towards the outer circumference of the assembly. The protective element 336 may give the wheel rim 334 a larger appearance which may be desirable for aesthetic purposes.

FIG. 3E is a cross-sectional illustration of an embodiment 344 showing a wheel rim 346, a protective element 348, and a tire 350. The protective element 348 conforms to and mounts to undulating surface 352.

FIG. 3F is a cross-sectional illustration of an embodiment 354 showing a wheel rim 356, a protective element 358, and a tire 360. The protective element 358 is attached to the surface 362 and features a tapered portion 364.

The various embodiments illustrate a variety of cross-sectional shapes of protective elements that may be attached to the exterior rim flange of a wheel rim. The various protective elements may attach in different manners and to different surfaces of the wheel rim. In many cases, the protective element may wrap around the exterior rim flange and come close to the interface of the wheel rim and the tire. The shape of the protective elements may be varied to give different aesthetic looks to the wheel assembly.

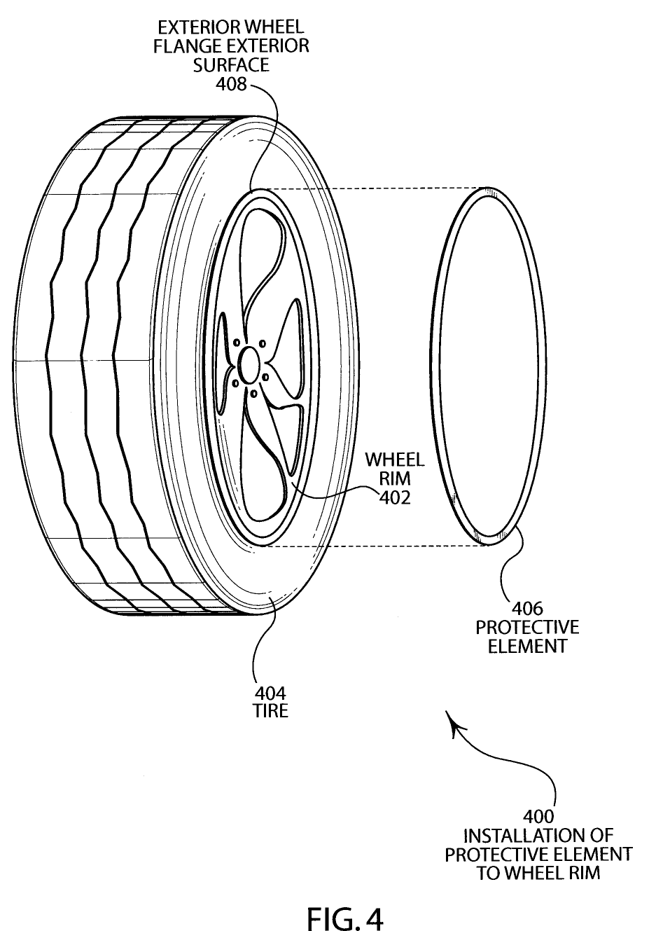

FIG. 4 is a semi-exploded perspective view of an embodiment 400 showing the installation of a protective element to a wheel rim. The wheel rim 402 has a mounted tire 404. The protective element 406 may be installed to the wheel rim 402 by mounting to the exterior surface of the exterior rim flange 408.

The embodiment 400 illustrates the attachment of a protective element 406 that is a single, continuous piece. Such an embodiment may be a single piece molded part that is molded, cast, stamped, machined, or otherwise appropriately manufactured.

The single piece protective element 406 may be attached to the exterior wheel flange 408 by any appropriate method, including adhesive bonding, mechanical fastening, or other method. Various mechanical fastening methods may be used, including removable or single use fasteners, spring clips, snap fit engagements, or other features. In some cases, the protective element 406 may mechanically engage features in the wheel flange 408. For example, a barbed end of a protuberance or other feature such as a snap on the protective element 406 may engage an appropriately sized hole or feature in the wheel rim 402.

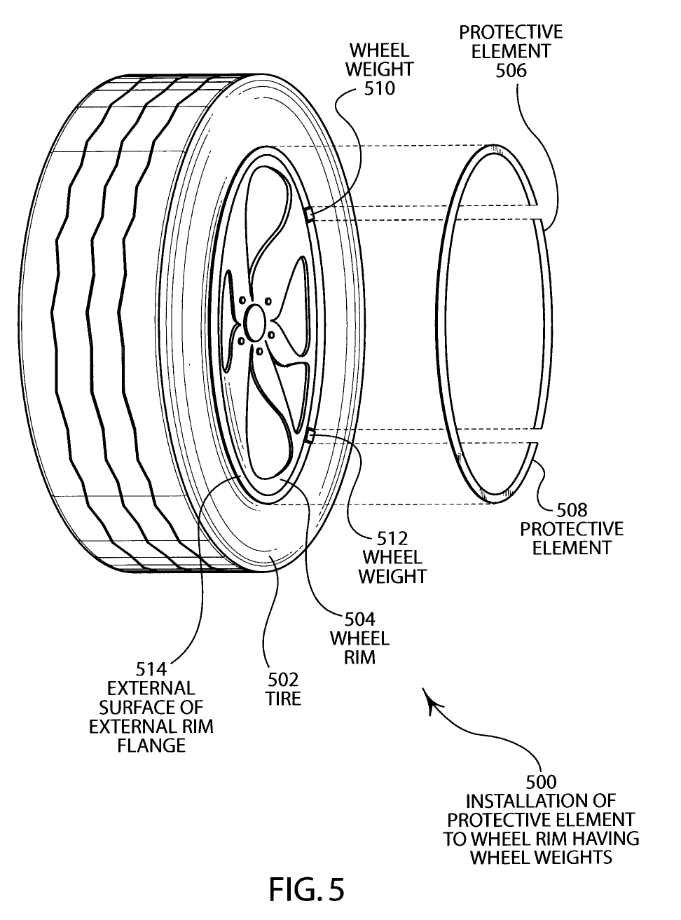

FIG. 5 is a semi-exploded perspective view of an embodiment 500 showing the installation of a protective element to a wheel rim that has wheel weights. The tire 502 is mounted to the wheel rim 504. The protective elements 506 and 508 may be placed along the external surface of the external wheel rim flange 514 but may avoid the area of the wheel weights 510 and 512.

The embodiment 500 may be an example of an installation where an extruded form of the protective elements 506 and 508 are used. In order to install the protective elements 506 and 508, a length of protective element extrusion may be cut from a large dispensing spool. An operator may attach the protective elements 506 and 508 to the surface 514 using any type of adhesive or mechanical fastening mechanism.

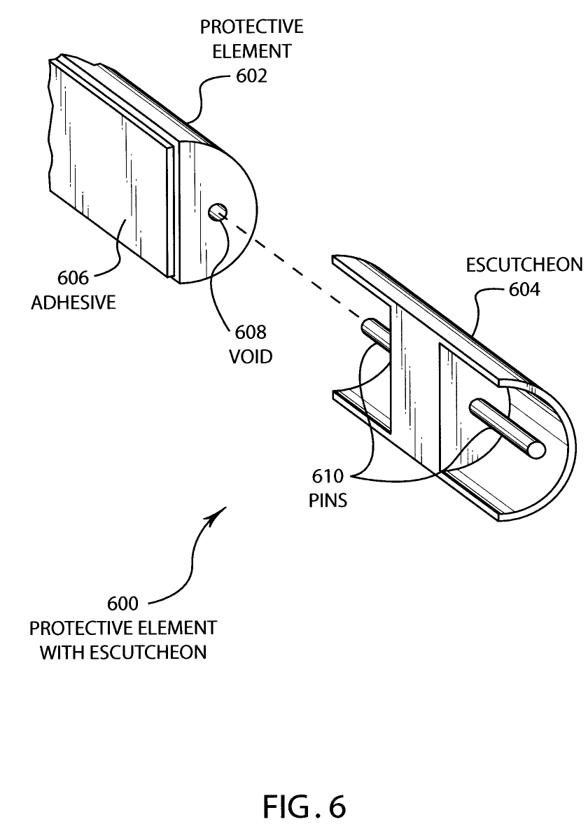

FIG. 6 is a perspective view of an embodiment 600 of a protective element with an escutcheon. A butt joint of the protective element 602 may be achieved with an escutcheon 604, although only one side of the butt joint is illustrated in the present figure. The protective element 602 may have an adhesive backing 606 and a void 608. The void 608 may accept one of the pins 610 to mechanically attach the escutcheon to the assembly. The other end of the butt joint, not illustrated, may similarly engage the remaining pin 610 during installation. The escutcheon 614 may be designed to cover two butt jointed ends of a protective embodiment. The portion of the escutcheon 614 in the area of the pins 610 may be designed to receive a portion of the end of the protective element 602 such that the end of the protective element is covered by the escutcheon 614.

The embodiment 600 illustrates how a butt joint may be achieved with an extruded protective element. A butt joint may be used when a single piece of extruded protective element is mounted to the external surface of an external wheel rim flange and no wheel weights or other discontinuities are encountered.

The embodiment 600 may use a purely mechanical engagement between the void 608 and the pins 610 to engage the escutcheon 604. The mechanical engagement may be a sliding fit, a slip fit, a press fit, or have some sort of interference between the pin 610 and the void 608. In other embodiments, an adhesive may be used to secure the escutcheon 604, including adhesive in the interface between the pin 610 and the void 608.

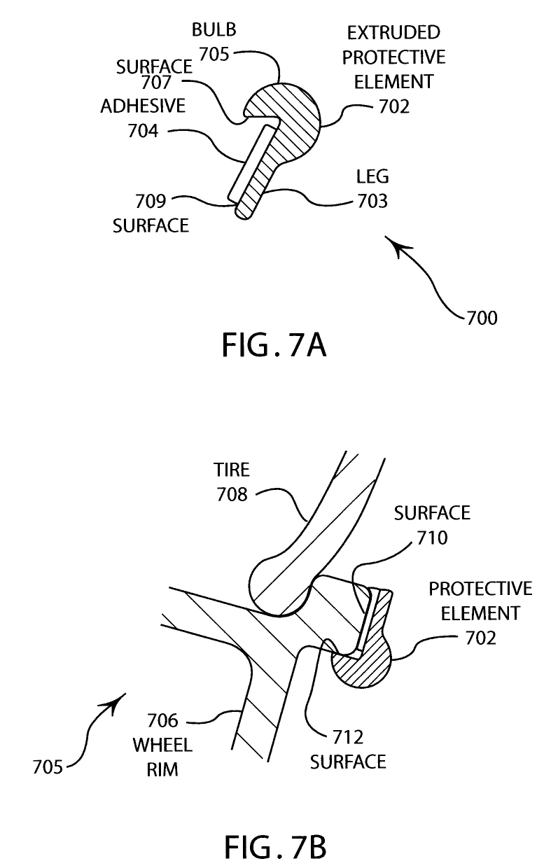

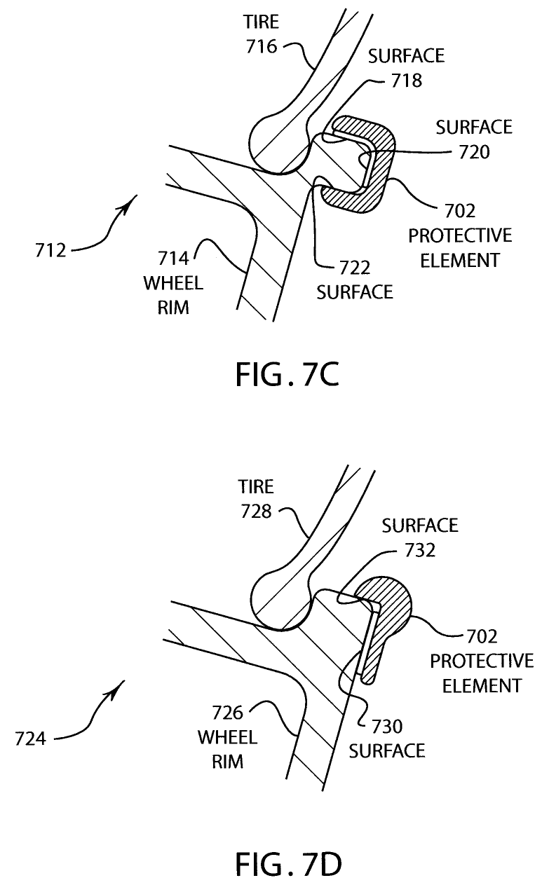

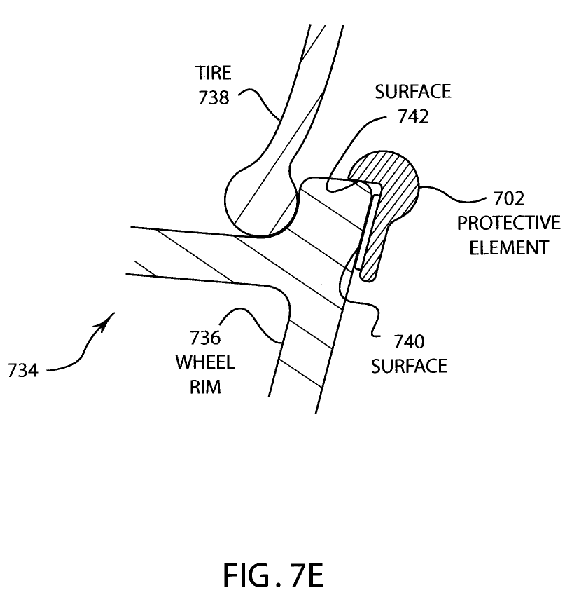

FIG. 7A is a cross-sectional illustration of an embodiment 700 showing a compliant protective element. The extruded protective element 702 has an adhesive material 704 applied to a leg end 703 and a bulbous end 705. The embodiment 700 may be constructed of a compliant material such that the leg portion 703 may be formed over a corner of a wheel rim and be held in place by the adhesive 704. The adhesive 704 may be a pressure sensitive adhesive. The surfaces 707 and 709 are oriented to be acute.

FIG. 7B is a cross-sectional illustration of an embodiment 705 showing an assembly with a compliant protective element 702. The wheel rim 706 has a tire 708 and the compliant protective element 702. The protective element 702 is attached to the surface 710 and covers the surface 712. The protective element 702 is mounted such that the bulbous end 705 is oriented towards the center of the wheel rim 706. The acute angle between surfaces 707 and 709 in the natural state may provide some compliance and force between the protective element 702 and the surface 712.

FIG. 7C is a cross-sectional illustration of an embodiment 712 showing an assembly with a compliant protective element 702. The wheel rim 714 has a tire 716 and the compliant protective element 702. The protective element 702 is attached to surfaces 718 and 720 using adhesive and covers the surface 722. The protective element 702 is attached by forming the leg portion 703 around the angle between the surfaces 718 and 720. The protective element 702 is mounted such that the bulbous end 705 is oriented toward the center of the wheel rim 714.

FIG. 7D is a cross-sectional illustration of an embodiment 724 showing an assembly with a compliant protective element 702. The wheel rim 726 has a tire 728 and the compliant protective element 702. The protective element 702 is attached to the surface 730 and covers surface 732. The protective element 702 is mounted such that the bulbous end 705 is oriented outward from the center of the wheel rim 726. The angle between the surfaces 730 and 732 is acute, but may be equal to or greater than the acute angle between surfaces 707 and 709.

FIG. 7E is a cross-sectional illustration of an embodiment 734 showing an assembly with a compliant protective element 702. The wheel rim 736 has a tire 738 and the compliant protective element 702. The protective element 702 is attached to the surface 740 and covers surface 742. The protective element 702 is mounted such that the bulbous end 705 is oriented toward the center of the wheel rim 736. The angle between the surfaces 740 and 742 is acute, but may be equal to or less than the acute angle between surfaces 707 and 709.

The various embodiments illustrate how a conformable and pliable protective element may be used in several different applications. The applications may use the protective element is different orientations and use the adhesive backed area to conform to the specific shape of the exterior surface of the wheel rim flange.

In some embodiments, the extruded protective element 702 may be manufactured from two or more different materials, a pliable and conformable material for the leg portion 703 and a stiffer and less conformable material for the bulbous portion 705.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. An automobile rim with a protective member comprising:
a wheel rim comprising:
an exterior side;
an interior side adapted to mount against a wheel hub;
an interior bead seat;
an exterior bead seat;
an exterior rim flange comprising an inner surface adapted to be disposed against a tire and an outer surface;
a protective member comprising:
an interior surface adapted to conform to said outer surface of said exterior rim flange;
wherein said protective member being manufactured from a non-metallic material; and
wherein said protective member is attached to said outer surface of said exterior rim flange of said wheel rim, said mounting being outside of said inner surface.

2. The automobile rim of claim 1 wherein said protective member is an extruded shape.

3. The automobile rim of claim 1 wherein said protective member is a molded shape.

4. The automobile rim of claim 3 wherein said molded shape is an annular shape.

5. The automobile rim of claim 1 wherein said protective member comprises an internal void within a cross sectional shape of said protective member.

6. The automobile rim of claim 1 wherein said protective member comprises a decorative film on an external surface.

7. The automobile rim of claim 1 wherein said protective member is attached to said wheel rim by pressure sensitive adhesive.

8. The automobile rim of claim 1 wherein said protective member is attached to said wheel rim by mechanical fastening means.

9. The automobile rim of claim 8 wherein said mechanical fastening means comprises spring clips.

10. The automobile rim of claim 8 wherein said mechanical fastening means comprises fasteners.

11. The automobile rim of claim 8 wherein said mechanical fastening means comprises engaging a retention feature in said wheel rim.

12. The automobile rim of claim 1 further comprising an escutcheon mounted on said protective member to cover a butt joint.

13. The automobile rim of claim 12 wherein said escutcheon is adapted to engage an internal void within a cross-sectional area of said protective member.

12. A method for applying a protective member to an automobile rim comprising:
presenting a wheel rim comprising an exterior side, an interior side adapted to mount against a wheel hub, an interior bead seat, an exterior bead seat, an exterior rim flange comprising an inner surface adapted to be disposed against a tire and an outer surface;
attaching a protective member to said wheel rim, said protective member having an attachment surface adapted to conform to said outer surface of said exterior rim flange, wherein said protective member is mounted outside of said inner surface of said exterior rim flange.

13. The method of claim 12 wherein said attaching comprises joining by pressure sensitive adhesive.

14. The method of claim 12 wherein said attaching comprises joining by mechanical fastening means.

15. The method of claim 14 wherein said mechanical fastening means comprises spring clips.

16. The method of claim 14 wherein said mechanical fastening means comprises fasteners.

17. The method of claim 14 wherein said mechanical fastening means comprises engaging a retention feature in said wheel rim.

18. The method of claim 12 wherein said protective member is an extruded shape.

19. The method of claim 12 wherein said protective member is a molded shape.

20. The method of claim 19 wherein said molded shape is an annual shape.

21. The method of claim 12 further comprising cutting said protective member to length.

22. The method of claim 21 wherein a first end of said protective member abuts a wheel weight.

23. The method of claim 12 further comprising cover a butt joint of said protective member with an escutcheon.

24. The method of claim 23 wherein said escutcheon is adapted to engage a void in the cross-sectional area of said protective member.
